(19) United States
(12) Patent Application Publication
(10) Pub. No.: US 2012/0150890 A1
(43) Pub. Date: Jun. 14, 2012

(54) METHOD OF SEARCHING FOR MULTIMEDIA CONTENTS AND APPARATUS THEREFOR

(75) Inventors: Hyuk JEONG, Daejeon (KR); Weon Geun OH, Daejeon (KR); Sang Il NA, Seoul (KR); Keun Dong LEE, Daejeon (KR); Sung Kwan JE, Daejeon (KR)

(73) Assignee: Electronics and Telecommunications Research Institute, Daejeon (KR)

(21) Appl. No.: 13/312,105

(22) Filed: Dec. 6, 2011

(30) Foreign Application Priority Data
Dec. 9, 2010 (KR) 10-2010-0125866

(51) Int. Cl. G06F 17/30

(52) U.S. Cl. 707/758; 707/E17.101

(57) ABSTRACT

Provided are a method of searching for multimedia contents and an apparatus therefor. The method includes separating an audio signal from indexing target multimedia contents and performing pre-processing on the audio signal, extracting a silence period of the audio signal, extracting an audio feature in at least one predetermined length period after an end point of the silence period, storing at least two of information for the multimedia contents, the audio feature and the end point of the silence period, to be associated with each other, in a database, and receiving the audio feature of the multimedia contents and searching the database for multimedia contents having the same or a similar audio feature as the search target multimedia contents.

### CLAIM FOR PRIORITY

This application claims priority to Korean Patent Application No. 10-2010-0125866 filed on Dec. 9, 2010 in the Korean Intellectual Property Office (KIPO), the entire contents of which are hereby incorporated by reference.

### BACKGROUND

1. Technical Field

Example embodiments of the present invention relate to a method of searching for multimedia contents and an apparatus therefor, and more particularly, to a method of searching for multimedia contents in which an audio feature of the multimedia contents is indexed so that large multimedia contents can be rapidly found, and an apparatus therefor.

2. Related Art

When a user has only part of contents among various audio/video contents on the Internet, technology for searching for contents containing the contents part is necessary. An audio signal synchronized with a video signal is generally contained in a video. Since a feature of the audio signal is easier in calculation and smaller in size than that of the video signal, the audio signal is utilized as a means for searching for video contents.

In order to search for contents based on the audio feature, the feature is robust to audio signal transformation such as re-sampling, lossy compression such as MP3, equalization, or the like, and real-time searching must be facilitated through a simple process.

For example, a method of creating an audio feature and an apparatus therefor are disclosed in Korean Patent Application Laid-open Publication No. 2004-0040409, in which spectral flatness of each sub-band is used as the audio feature. In this Patent Document, an audio feature suitable for different requirements is provided, but this value does not have a feature that is robust against distortions of the audio signal.

Meanwhile, an audio copy detector is disclosed in Korean Patent Application Laid-open Publication No. 2005-0039544, in which a Fourier transform coefficient with an overlapped window (modulated complex lapped transform; MCLT) is used as an audio feature, and distortion discriminant analysis (DDA) is used to decrease a length of the audio feature and increase robustness of the audio feature. However, such distortion discriminant analysis has a complex process and it takes a long time to search for an audio file.

### SUMMARY

Accordingly, example embodiments of the present invention are provided to substantially obviate one or more problems due to limitations and disadvantages of the related art.

Example embodiments of the present invention provide a method of searching for multimedia contents using a feature value of an audio signal, which is robust against transformation of an audio signal contained in the multimedia contents and makes real-time searching easy through a simple process.

Example embodiments of the present invention also provide an apparatus for searching for multimedia contents using a feature value of an audio signal, which is robust against transformation of an audio signal contained in the multimedia contents and makes real-time searching easy through a simple process.

In some example embodiments, a method of searching for multimedia contents includes extracting an audio signal from indexing target multimedia contents and performing pre-processing on the audio signal; extracting a silence period of the pre-processed audio signal; extracting an audio feature in at least one predetermined length period after an end point of the extracted silence period; storing at least two of information for the multimedia contents, the extracted audio feature, and the end point of the silence period, to be associated with each other, in a database; and receiving the audio feature of search target multimedia contents and searching the database for multimedia contents having the same or a similar audio feature as the search target multimedia contents.

Here, the pre-processing may include extracting the audio signal from the indexing target multimedia contents; converting the audio signal into a mono signal; and re-sampling the mono signal at a predetermined frequency.

Here, the extracting of the silence period may include extracting period-specific acoustic power of the pre-processed audio signal; and recognizing the silence period by comparing the period-specific acoustic power with a predetermined threshold value. In this case, in the extracting of period-specific acoustic power, the period may be arranged at predetermined intervals and each period may partially overlap a previous period. In this case, the recognizing of the silence period may include recognizing a period in which the acoustic power is equal to or less than a predetermined threshold as the silence period when a predetermined number of the periods appear continuously.

Here, the extracting of the audio feature may include obtaining a power spectrum of the audio signal in at least one specific period with reference to a time at which the silence period recognized in the extracting of the silence period ends, dividing the power spectrum obtained in the specific period into a predetermined number of sub-bands, summing sub-band-specific spectra to obtain sub-band-specific power, and extracting an audio feature value based on the obtained sub-band-specific power.

In other example embodiments, an apparatus for searching for multimedia contents includes an audio signal extraction and pre-processing unit configured to separate an audio signal from indexing target multimedia contents and perform pre-processing on the audio signal; an acoustic power extraction unit configured to calculate acoustic power of a period having a predetermined length at predetermined time intervals for the pre-processed audio signal; a silence period extraction unit configured to extract a silence period based on the acoustic power of a period having a predetermined length at predetermined time intervals, calculated by the acoustic power extraction unit; an audio feature extraction unit configured to extract an audio feature in at least one predetermined length period after an end point of the extracted silence period; a database unit configured to store the multimedia contents, the audio feature extracted by the audio feature extraction unit, and the end point of the silence period extracted by the silence period extraction unit, to be associated with one another; and a database search unit configured to receive the audio feature of search target multimedia contents from a user, and search the database for multimedia contents having the same or a similar audio feature as the search target multimedia contents.

Here, the audio signal extraction and pre-processing unit may be configured to extract the audio signal from indexing target multimedia contents, convert the extracted audio signal into a mono signal, and re-sample the mono signal at a predetermined frequency.

Here, the periods in which the acoustic power extraction unit calculates the acoustic power may be arranged at predetermined intervals, in which each period may be overlapped with a previous period.

Here, the silence period extraction unit may recognize the silence period by comparing acoustic power of a period having a predetermined length at predetermined time intervals with a predetermined threshold value. In this case, the silence period extraction unit may recognize a period in which the acoustic power is equal to or less than a predetermined threshold as the silence period when a predetermined number of the periods appear continuously.

Here, the audio feature extraction unit may be configured to obtain a power spectrum of the audio signal in at least one specific period with reference to a time at which the recognized silence period ends, divide the power spectrum obtained in the specific period into a predetermined number of sub-bands, sum sub-band-specific spectra to obtain sub-band-specific power, and extract an audio feature value based on the sub-band-specific power.

In the method of searching for multimedia contents according to an example embodiment of the present invention and the apparatus therefor, a complex process is unnecessary and a feature value of a specific portion of an audio signal is extracted and used instead of a global feature of the audio signal. The method is more efficient than a method in which a global feature of an audio signal is stored and used for searching.

In particular, in the method and the apparatus of an example embodiment of the present invention, a search target audio feature exhibits a robust characteristic against a variety of distortions such as re-sampling and equalization. Further, a transformation-invariant feature value is located in an upper bit, making searching easy through indexing of the feature value. Accordingly, it is possible to search for video/audio containing a video/audio sample from a large video/audio database using the sample in real time.

### BRIEF DESCRIPTION OF DRAWINGS

Example embodiments of the present invention will become more apparent by describing in detail example embodiments of the present invention with reference to the accompanying drawings, in which:

FIG. 1 is a flowchart illustrating a method of searching for multimedia contents according to an example embodiment of the present invention.

FIG. 2 is a flowchart illustrating an audio pre-processing step in the method of searching for multimedia contents according to an example embodiment of the present invention.

FIG. 3 is a conceptual diagram illustrating a structure of an audio feature value calculated in the method of searching for multimedia contents according to an example embodiment of the present invention.

FIG. 4 is a block diagram illustrating a configuration of a multimedia contents search apparatus according to an example embodiment of the present invention.

### DESCRIPTION OF EXAMPLE EMBODIMENTS OF THE PRESENT INVENTION

Example embodiments of the present invention are disclosed herein. However, specific structural and functional details disclosed herein are merely representative for purposes of describing example embodiments of the present invention, however, example embodiments of the present invention may be embodied in many alternate forms and should not be construed as limited to example embodiments of the present invention set forth herein.

Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of an example embodiment of the present invention. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between”, “adjacent” versus “directly adjacent”, etc.).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein. (the above paragraphs contain errors—please replace with proofread versions)

Hereinafter, preferred example embodiments of the present invention will be described in detail with reference to the accompanying drawings.

When scenes in a video of animation, movie or the like are switched, there is a silence period in which an acoustic level is very low. In an example embodiment of the present invention, a feature for a certain time is obtained at a time when the acoustic level is above a threshold level after the silence ends, subjected to hash processing, and used as an index indicating a specific video.

More specifically, an example embodiment of the present invention relates to a system for extracting a silence period from an acoustic signal extracted from an audio source such as a compact disc (CD) or a video, obtaining an audio feature for a certain time from an end of the silence period, hash-processing the audio feature to create an index structure, and searching for the audio feature from an existing large multimedia contents database to search for multimedia contents (audio/video) containing an unknown audio signal.

Hereinafter, the method of searching for multimedia contents according to an example embodiment of the present invention and the apparatus therefor will be sequentially described.

### Method of Searching for Multimedia Contents According to Example Embodiment of the Present Invention

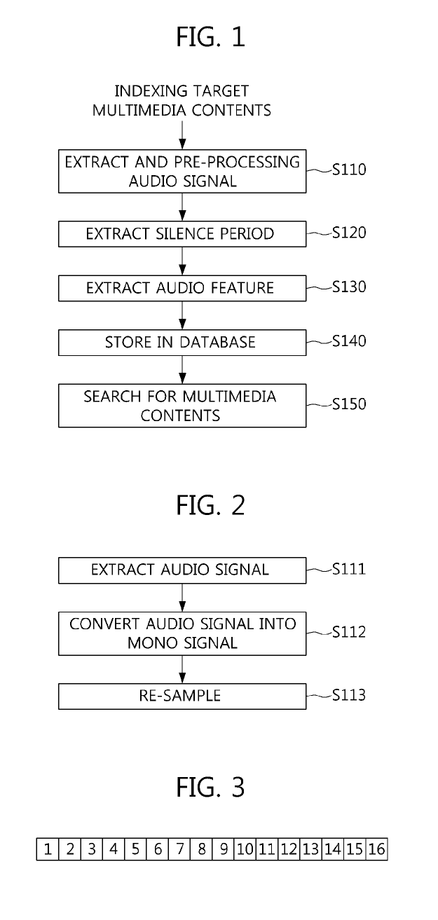

FIG. 1 is a flowchart illustrating the method of searching for multimedia contents according to an example embodiment of the present invention.

Referring to FIG. 1, the method of searching for multimedia contents according to an example embodiment of the present invention includes step S110 of extracting and pre-processing an audio signal, step S120 of extracting a silence period of the pre-processed audio signal, step S130 of extracting an audio feature in a period after an end point of the extracted silence period, step S140 of storing the multimedia contents, the extracted audio feature, and the end point of the silence period to be associated with one another, and step S150 of receiving the audio feature as a search target and searching for multimedia contents having the same or a similar audio feature as the extracted audio feature from the database.

First, in the audio extraction and pre-processing step S110, an audio signal is extracted from the multimedia contents and pre-processing is performed on the extracted audio signal.

The audio extraction and pre-processing step S110 will be described in detail below.

FIG. 2 is a flowchart illustrating the audio extraction and pre-processing step S110 in the method of searching for multimedia contents according to an example embodiment of the present invention.

Referring to FIG. 2, the audio extraction and pre-processing step S110 includes an audio signal extraction step S111, an audio signal-mono signal conversion step S112, and a re-sampling step S113.

In the audio extraction step S111, an audio signal is extracted from multimedia contents to be indexed and stored in the database. That is, when the multimedia contents to be indexed includes video and audio signals, only the audio signal is extracted. It is understood that when the multimedia contents to be indexed includes only an audio signal, the audio signal may be used as an extracted audio signal. Since the feature of the audio signal is easier in calculation and smaller in size than that of the video signal as described in the Background, the audio signal extracted from the multimedia contents is used as a means for searching for video multimedia contents. Accordingly, step S111 is performed.

Next, in the audio signal-mono signal conversion step S112, the extracted audio signal is converted into a mono signal.

In a process of converting a signal into a mono signal, a scheme of averaging all channel signals may be used. The extracted audio signal is converted into the mono signal because a multi-channel audio signal is unnecessary for extraction of an audio feature and, accordingly, the mono signal is used to decrease a calculation amount of subsequent extraction of the audio feature and to increase efficiency of a search process.

Next, in the re-sampling step S113, the audio signal obtained in the audio signal-mono signal conversion step S112 is subjected to a process of re-sampling at a predetermined frequency to decrease a calculation amount in a subsequent process, to increase efficiency, and to cause the indexed and stored audio features to have the same sampling frequency. Here, a re-sampling frequency is preferably set to be in a range from 5500 Hz to 6000 Hz, but may be changed, if necessary.

Referring back to FIG. 1, in step S120 of extracting a silence period of the pre-processed audio signal, period-specific acoustic power of the pre-processed audio signal is extracted and compared with a predetermined threshold value to recognize the silence period.

First, in order to extract the silence period, the pre-processed audio signal is divided into specific time periods and the power in each period is obtained. For example, for the length of the period in which the acoustic power is obtained, the acoustic power may be calculated at about 10 ms intervals to recognize the silence period since a silence period contained in a video editing process usually is from tens of ms to hundreds of ms. However, the period interval of 10 ms may vary with the indexing target multimedia contents, if necessary.

The length of the audio signal period in which the acoustic power is calculated is about 20 ms and the periods are overlapped with each other by 50% to calculate the acoustic power. If xᵢ is an i-th audio signal and N is the number of audio signals in the period, the acoustic power Pₙ in the n-th period is obtained by squaring and summing all x, in the period and dividing the result by N. A process of calculating the acoustic power may be represented by Equation 1.

$${P}_{n} = \frac{1}{N} {\sum }_{i = k}^{k + N - 1} {x}_{i}^{2} \qquad [ Equation 1 ]$$

A period in which the acoustic power in each period using Equation 1 is equal to or less than a specific threshold is recognized. If this period is greater than a specific time (about 200 ms), the period is set as a silence period. In this case, a position (time) at which the silence period ends is recorded and delivered to the next step (S130) of extracting an audio feature.

In step S130 of extracting an audio feature, a power spectrum of the audio signal is obtained in at least one specific period with reference to a time at which the silence period extracted in step S120 of extracting a silence period ends.

Further, the power spectrum obtained in each period is divided into a few sub-bands and spectra in the respective frequency bands are summed to obtained sub-band power. The sub-band may be set to be proportional to a critical bandwidth in consideration of human auditory characteristics.

In this case, the audio feature may be extracted based on the obtained sub-band-specific power. An illustrative example of extracting an audio feature will be described below. In the method of extracting an audio feature that will be described later, power spectra of the audio signal are obtained in two specific periods with reference to a time at which the silence period ends and the audio feature is extracted. However, the extraction of the audio feature according to an example embodiment of the present invention is not necessarily extraction of the audio feature in the two specific periods. For example, the audio feature may be extracted in one specific period or two or more specific periods (for example, if the audio feature is extracted only in one specific period, Bᵢ (i=1 to 16) in Equation 2 may be understood to be all 0.

In the example embodiment of the present invention, in a first period in which the power spectrum is obtained, 256 data samples are taken in a position in which the silence ends. In the second period, 256 data samples are taken in the 101-th position from the position in which the silence ends. For the sub-band, a period from 200 Hz to 2000 Hz in which important most acoustic information is contained is divided into 16 periods with reference to a critical bandwidth. However, it is to be understood that the number of sub-bands and the period in which the power spectrum is obtained may be variously set according to a system implementation method.

In this case, if sub-band power in the first period is A, (i=1, 2, . . . , 16) in order from a low frequency to a high frequency and sub-band power in the second period is Bᵢ, a feature value Zₖ at the k-th bit (k=1, 2, . . . , 16) of 16 bits may be represented by Equations 2.

$$if {\sum }_{i = 1}^{16} {A}_{i} - {\sum }_{i = 1}^{16} {B}_{i} > 0 , {Z}_{1} = 1 , otherwise {Z}_{1} = 0 \\ if ( {\sum }_{i = 1}^{8} {A}_{i} - {\sum }_{i = 1}^{8} {B}_{i} ) - ( {\sum }_{i = 9}^{16} {A}_{i} - {{\sum }_{i = 9}}^{16} {B}_{i} ) > 0 , {Z}_{2} = 1 , \\ otherwise {Z}_{2} = 0 \\ if ( {\sum }_{i = 1}^{4} {A}_{i} - {\sum }_{i = 1}^{4} {B}_{i} ) - ( {\sum }_{i = 5}^{8} {A}_{i} - {\sum }_{i = 5}^{8} {B}_{i} ) > 0 , {Z}_{3} = 1 , \\ otherwise {Z}_{3} = 0 \\ if ( {\sum }_{i = 9}^{12} {A}_{i} - {\sum }_{i = 9}^{12} {B}_{i} ) - ( {\sum }_{i = 13}^{16} {A}_{i} - {\sum }_{i = 13}^{16} {B}_{i} ) > 0 , {Z}_{4} = 1 , \\ otherwise {Z}_{4} = 0 \\ if ( {\sum }_{i = 1}^{2} {A}_{i} - {\sum }_{i = 1}^{2} {B}_{i} ) - ( {\sum }_{i = 3}^{4} {A}_{i} - {\sum }_{i = 3}^{4} {B}_{i} ) > 0 , {Z}_{5} = 1 , \\ otherwise {Z}_{5} = 0 \\ if ( {\sum }_{i = 5}^{6} {A}_{i} - {\sum }_{i = 5}^{6} {B}_{i} ) - ( {\sum }_{i = 7}^{8} {A}_{i} - {\sum }_{i = 7}^{8} {B}_{i} ) > 0 , {Z}_{6} = 1 , \\ otherwise {Z}_{6} = 0 \\ if ( {\sum }_{i = 9}^{10} {A}_{i} - {\sum }_{i = 9}^{10} {B}_{i} ) - ( {\sum }_{i = 11}^{12} {A}_{i} - {\sum }_{i = 11}^{12} {B}_{i} ) > 0 , {Z}_{7} = 1 , \\ otherwise {Z}_{7} = 0 \\ if ( {\sum }_{i = 13}^{14} {A}_{i} - {\sum }_{i = 13}^{14} {B}_{i} ) - ( {\sum }_{i = 15}^{16} {A}_{i} - {\sum }_{i = 15}^{16} {B}_{i} ) > 0 , {Z}_{8} = 1 , \\ otherwise {Z}_{8} = 0 \\ When i = 9 , 10 , … , 16 , \\ if ( {A}_{2 \cdot ( i - 9 ) + 1} - {B}_{2 \cdot ( i - 9 ) + 1} ) - ( {A}_{2 \cdot ( i - 9 ) + 2} - {B}_{2 \cdot ( i - 9 ) + 2} ) > 0 , \\ {Z}_{i} = 1 , otherwise {Z}_{i} = 0 \qquad [ Equation 2 ]$$

FIG. 3 is a conceptual diagram illustrating a structure of an audio feature value calculated in the method of searching for multimedia contents according to the example embodiment of the present invention.

Referring to FIG. 3, feature values Zₖ consist of 16 bits, in which the first bit has the highest value. Accordingly, the feature values have the same contents, but when an audio signal is partially distorted due to, for example, band pass filtering, only bits having lower values are transformed, which is very advantageous for indexing and processing feature values.

In other words, for audio signals containing the same contents, the value of the first bit is not transformed but maintained as long as the transformation does not cause severe distortion, since acoustic power differences between neighboring frames are compared. Accordingly, higher bits of the feature value are less likely to be transformed, and audio signals are highly likely to have similar contents though a few lower bits differ from one another. Accordingly, when the feature values are indexed, higher values may be first compared and then lower values may be compared for high search efficiency.

Several feature values may be extracted with reference to one silence position, and assigned to important bit positions in order of increasing distortion due to signal transformation.

Next, step S140 of storing the multimedia contents in the database is a step of storing the multimedia contents, the extracted audio feature, and the end point of the silence period to be associated with one another in the database.

That is, in step S140 of storing the multimedia contents in the database, at least two pieces of information (file name, ID for specifying, file position, etc.) of the multimedia contents (video plus audio, or audio), the extracted audio feature value, and time information of an audio signal period in which the audio feature value has been extracted are stored to be associated with one another in the database.

In this case, the time information of the audio signal period in which the audio feature value has been extracted may be time information of a time at which a silence period directly before an audio signal period in which the audio feature value has been extracted ends.

Last, in the database search step S150, an audio feature of multimedia contents as a search target is received and searched for in the database, and information on the corresponding multimedia contents is provided to the user.

### Multimedia Contents Search Apparatus According to Example Embodiment of the Present Invention

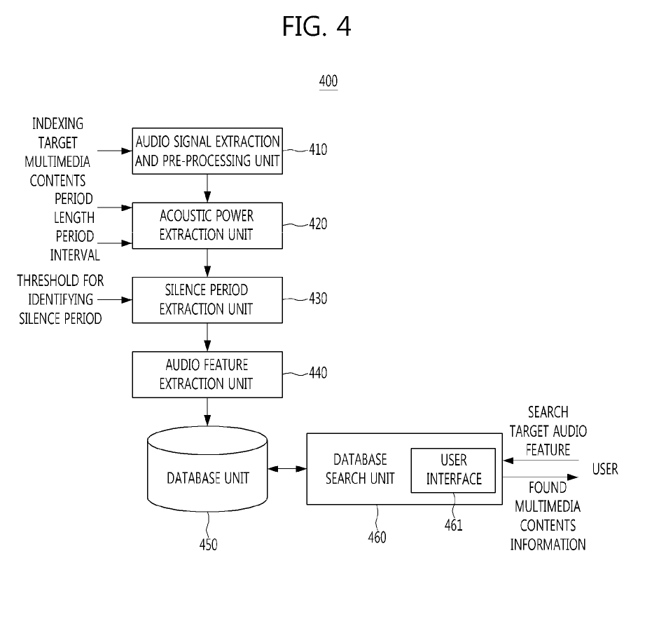

FIG. 4 is a block diagram illustrating a configuration of a multimedia contents search apparatus according to an example embodiment of the present invention.

Referring to FIG. 4, a multimedia contents search apparatus 400 according to an example embodiment of the present invention includes an audio signal extraction and pre-processing unit 410, an acoustic power extraction unit 420, a silence period extraction unit 430, an audio feature extraction unit 440, a database unit 450, and a database search unit 460.

First, the audio signal extraction and pre-processing unit 410 is a component for performing the audio signal extraction and pre-processing step S110 of the multimedia contents search method, which has been described with reference to FIG. 1. That is, the audio signal extraction and pre-processing unit 410 is a component for extracting an audio signal from multimedia contents as an indexing target and performing pre-processing on the extracted audio signal.

The audio signal extraction and pre-processing unit 410 extracts the audio signal from the multimedia contents to be indexed and stored in the database, converts the extracted audio signal into a mono signal, and re-samples the mono signal at a predetermined frequency (e.g., 5500 Hz to 6000 Hz) to decrease a calculation amount and improve efficiency.

Accordingly, the audio signal extraction and pre-processing unit 410 may include a component for identifying a file format of the indexing target multimedia contents, and reading, for example, a meta data area to divide an audio stream and a video stream in the multimedia contents. In particular, when the divided audio signal has been encoded using a specific scheme, a process of decoding the audio signal may be necessary for conversion into the mono signal or re-sampling. Accordingly, the audio signal extraction and pre-processing unit 410 may include various types of decoders to correspond to a variety of formats of an audio signal, and may further include a component for decoding the extracted audio signal based on the above-described file format or meta data information.

Next, the acoustic power extraction unit 420 and the silence period extraction unit 430 are components for performing step S120 of extracting a silence period of an audio signal in the method of searching for multimedia contents according to the example embodiment of the present invention, which has been described with reference to FIG. 1.

That is, the acoustic power extraction unit 420 calculates acoustic power of the audio signal in a predetermined length period at predetermined time intervals using Equation 1, and the silence period extraction unit 430 recognizes the silence period in the audio signal using a predetermined threshold value.

In this case, since set values such as the time interval of the period in which the acoustic power extraction unit 420 calculates the acoustic power, the length of the period, and the threshold value used for the silence period extraction unit 430 identifies the silence period may vary with a system environment, the set values may be changed and set by the user. For example, if the acoustic power extraction unit 420 and the silence extraction unit 430 are configured of hardware such as a field programmable gate array (FPGA) or an application specific integrated circuit (ASIC), the set values may be changed through a predetermined setup register. If the acoustic power extraction unit 420 and the silence extraction unit 430 are implemented by software, the set values may be changed through variable values.

Next, the audio feature extraction unit 440 is a component for performing step S130 of extracting an audio feature in the method of searching for multimedia contents according to the example embodiment of the present invention, which has been described with reference to FIG. 1. The audio feature extraction unit 440 may be configured to extract an audio feature in at least one predetermined length period after an end point of the extracted silence period using, for example, Equation 2. A description of the method of extracting the audio feature in the audio feature extraction unit 440 will be omitted since it is the same as step S130 of extracting an audio feature, which has been described with reference to FIG. 1.

The database unit 450 is a component for storing at least one of information (file name and file position) on indexing target multimedia contents, the audio feature extracted by the audio feature extraction unit, and the end point of the silence period extracted by the silence period extraction unit, to be associated with each other.

Here, the database unit includes a database management system (DBMS), and may store the above-described information irrespective of a database format (relational or object-oriented).

Last, the database search unit 460 is a component for receiving the audio feature of search target multimedia contents from the user, and searching the database unit for multimedia contents having the same or a similar audio feature as the search target multimedia contents. That is, the database search unit 460 performs database query in response to a request from the user. Further, the database search unit 460 may include a user interface 461 capable of receiving the audio feature of the search target multimedia contents from the user and outputting a search result.

It is to be noted that the component of the database search unit 460 receives the audio feature of the search target multimedia contents and searches the database unit 450, but the component may receive the search target multimedia contents other than the audio feature of the search target multimedia contents from the user.

However, the database search unit 460 illustrated in FIG. 4 is assumed to receive the audio feature value extracted from the search target multimedia contents. The process of extracting the audio feature from the search target multimedia contents may be performed by a separate component so that all or some of the audio signal extraction and pre-processing step S110 of separating the audio signal from the multimedia contents and pre-processing the audio signal, step S120 of extracting a silence period of the pre-processed audio signal, and the audio feature extraction step S130 of extracting an audio feature in at least one predetermined length period after an end point of the extracted silence period, which have been described with reference to FIG. 1, are performed to extract the audio feature value and input the audio feature value to the database search unit 450.

While example embodiments of the present invention and their advantages have been described in detail, it should be understood that various changes, substitutions and alterations may be made herein without departing from the scope of the invention.

### BRIEF DESCRIPTION OF REFERENCE NUMERALS

400: multimedia contents search apparatus
410: audio signal extraction and pre-processing unit
420: acoustic power extraction unit
430: silence period extraction unit
440: audio feature extraction unit
450: database unit
460: database search unit
461: user interface

What is claimed is:

1. A method of searching for multimedia contents, the method comprising:
extracting an audio signal from indexing target multimedia contents and performing pre-processing on the audio signal;
extracting a silence period of the pre-processed audio signal;
extracting an audio feature in at least one predetermined length period after an end point of the extracted silence period;
storing at least two of information for the multimedia contents, the extracted audio feature, and the end point of the silence period, to be associated with each other, in a database; and
receiving the audio feature of search target multimedia contents and searching the database for multimedia contents having the same or a similar audio feature as the search target multimedia contents.

2. The method of claim 1, wherein the pre-processing comprises:
extracting the audio signal from the indexing target multimedia contents;
converting the audio signal into a mono signal; and
re-sampling the mono signal at a predetermined frequency.

3. The method of claim 1, wherein the extracting of the silence period comprises:
extracting period-specific acoustic power of the pre-processed audio signal; and
recognizing the silence period by comparing the period-specific acoustic power with a predetermined threshold value.

4. The method of claim 3, wherein the period in the extracting of period-specific acoustic power is arranged at predetermined intervals and each period partially overlaps a previous period.

5. The method of claim 3, wherein the recognizing of the silence period comprises recognizing a period in which the acoustic power is equal to or less than a predetermined threshold as the silence period when a predetermined number of the periods appear continuously.

6. The method of claim 1, wherein the extracting of the audio feature comprises obtaining a power spectrum of the audio signal in at least one specific period with reference to a time at which the silence period recognized in the extracting of the silence period ends, dividing the power spectrum obtained in the specific period into a predetermined number of sub-bands, summing sub-band-specific spectra to obtain sub-band-specific power, and extracting an audio feature value based on the obtained sub-band-specific power.

7. An apparatus for searching for multimedia contents, the apparatus comprising:
an audio signal extraction and pre-processing unit configured to separate an audio signal from indexing target multimedia contents and perform pre-processing on the audio signal;
an acoustic power extraction unit configured to calculate acoustic power of a period having a predetermined length at predetermined time intervals for the pre-processed audio signal;
a silence period extraction unit configured to extract a silence period based on the acoustic power of a period having a predetermined length at predetermined time intervals, calculated by the acoustic power extraction unit;
an audio feature extraction unit configured to extract an audio feature in at least one predetermined length period after an end point of the extracted silence period;
a database unit configured to store the multimedia contents, the audio feature extracted by the audio feature extraction unit, and the end point of the silence period extracted by the silence period extraction unit, to be associated with one another; and
a database search unit configured to receive the audio feature of search target multimedia contents from a user, and search the database for multimedia contents having the same or a similar audio feature as the search target multimedia contents.

8. The apparatus of claim 7, wherein the audio signal extraction and pre-processing unit extracts the audio signal from indexing target multimedia contents, converts the extracted audio signal into a mono signal, and re-samples the mono signal at a predetermined frequency.

9. The apparatus of claim 7, wherein the periods in which the acoustic power extraction unit calculates the acoustic power are arranged at predetermined intervals, and each period is overlapped with a previous period.

10. The apparatus of claim 7, wherein the silence period extraction unit recognizes the silence period by comparing acoustic power of a period having a predetermined length at predetermined time intervals with a predetermined threshold value.

11. The apparatus of claim 10, wherein the silence period extraction unit recognizes a period in which the acoustic power is equal to or less than a predetermined threshold as the silence period when a predetermined number of the periods appear continuously.

12. The apparatus of claim 7, wherein the audio feature extraction unit obtains a power spectrum of the audio signal in at least one specific period with reference to a time at which the recognized silence period ends, divides the power spectrum obtained in the specific period into a predetermined number of sub-bands, sums sub-band-specific spectra to obtain sub-band-specific power, and extracts an audio feature value based on the sub-band-specific power.
